(19) United States
(12) Patent Application Publication
(10) Pub. No.: US 2026/0196031 A1
(43) Pub. Date: Jul. 9, 2026

(54) METHOD AND DEVICE FOR IMPROVING RECOGNITION ACCURACY OF OBJECT ATTRIBUTES

(71) Applicant: Lenovo (Beijing) Limited, Beijing (CN)

(72) Inventors: Jianfeng WANG, Beijing (CN); Luning LIU, Beijing (CN); Haiming WANG, Beijing (CN)

(21) Appl. No.: 19/560,700

(22) Filed: Mar. 9, 2026

Related U.S. Application Data
(63) Continuation of application No. PCT/CN2024/098389, filed on Jun. 11, 2024.

(30) Foreign Application Priority Data
Sep. 25, 2023 (CN) 202311243683.9

(51) Int. Cl. G06V 10/776; G06V 10/74

(52) U.S. Cl. CPC G06V 10/776; G06V 10/74

(57) ABSTRACT

The present disclosure discloses a method for improving recognition accuracy of object attributes. The method is performed by a target node and includes: obtaining first attribute data of a target object in a sensing region; in response to the first attribute data failing to satisfy a predetermined sensing condition, querying nodes by the target node to determine N target auxiliary nodes matching the first attribute data, where N is a positive integer greater than or equal to 1; and, obtaining data from the N target auxiliary nodes, where the data includes second attribute data of the target object in the sensing region, and an accuracy of the second attribute data is higher than an accuracy of the first attribute data.

### CROSS-REFERENCES TO RELATED APPLICATIONS

This application is a continuation application of International Application No. PCT/CN2024/098389, filed on Jun. 11, 2024, which claims priority to Chinese Patent Application No. 202311243683.9, filed on Sep. 25, 2023, the content of all of which is incorporated herein by reference in their entirety.

### TECHNICAL FIELD

The present disclosure relates to the field of data processing, and more specifically, relates to a method and a device for improving recognition accuracy of object attributes.

### BACKGROUND

In a sensing region, if objects such as persons or items appear, wireless sensing technology may be used to obtain parameters of the objects in the sensing region, such as distance and orientation. At present, acquisition of these parameters of the objects may suffer from insufficient accuracy. How to improve acquisition accuracy has become a technical problem that is urgently required to be addressed.

### SUMMARY

One aspect of the present disclosure provides a method for improving recognition accuracy of object attributes. The method is performed by a target node and includes: obtaining first attribute data of a target object in a sensing region; in response to the first attribute data failing to satisfy a predetermined sensing condition, querying nodes by the target node to determine N target auxiliary nodes matching the first attribute data, where N is a positive integer greater than or equal to 1; and, obtaining data from the N target auxiliary nodes, where the data includes second attribute data of the target object in the sensing region, and an accuracy of the second attribute data is higher than an accuracy of the first attribute data.

Another aspect of the present disclosure provides a device for improving recognition accuracy of object attributes. The device is configured as a target node, and includes a processor, and a transceiver. The processor is configured to: obtain first attribute data of a target object in a sensing region; and, in response to the first attribute data failing to satisfy a predetermined sensing condition, query nodes to determine N target auxiliary nodes matching the first attribute data, where N is a positive integer greater than or equal to 1. The transceiver is configured to obtain data from the N target auxiliary nodes. The data includes second attribute data of the target object in the sensing region, and an accuracy of the second attribute data is higher than an accuracy of the first attribute data.

Yet another aspect of the present disclosure provides a non-transitory computer-readable storage medium storing a computer program. The computer program, when executed by a processor of a device configured as a target node, causes the processor to perform operations. The operations include: obtaining first attribute data of a target object in a sensing region; in response to the first attribute data failing to satisfy a predetermined sensing condition, querying nodes by the target node to determine N target auxiliary nodes matching the first attribute data, where N is a positive integer greater than or equal to 1; and, obtaining data from the N target auxiliary nodes. The data includes second attribute data of the target object in the sensing region, and an accuracy of the second attribute data is higher than an accuracy of the first attribute data.

### BRIEF DESCRIPTION OF THE DRAWINGS

The above and other objectives, features, and advantages of exemplary embodiments of the present disclosure will become readily understood from the following detailed description when read in conjunction with the accompanying drawings. In the drawings, several embodiments of the present disclosure are illustrated by way of example rather than limitation. In the drawings, the same or corresponding reference numerals denote the same or corresponding parts.

FIG. 1(a) to FIG. 1(d) illustrate schematic diagrams of sensing region coverage of nodes of two roles in accordance with some embodiments of the present disclosure.

FIG. 2 illustrates a schematic flowchart of a method for improving recognition accuracy of object attributes in accordance with some embodiments of the present disclosure.

FIG. 3 illustrates a schematic flowchart of a method for improving recognition accuracy of object attributes under application scenario one in accordance with some embodiments of the present disclosure.

FIG. 4 illustrates a schematic flowchart of a method for improving recognition accuracy of object attributes under application scenario two in accordance with some embodiments of the present disclosure.

FIG. 5 illustrates a schematic flowchart of a method for improving recognition accuracy of object attributes under application scenario three in accordance with some embodiments of the present disclosure.

FIG. 6 illustrates a schematic structural diagram of a device for improving recognition accuracy of object attributes in accordance with some embodiments of the present disclosure.

FIG. 7 illustrates another schematic structural diagram of a device for improving recognition accuracy of object attributes in accordance with some embodiments of the present disclosure.

FIG. 8 illustrates a schematic structural diagram of an electronic device in accordance with some embodiments of the present disclosure.

### DETAILED DESCRIPTION

To make the objectives, features, and advantages of the present disclosure more apparent and readily understood, the technical solutions of embodiments of the present disclosure are described clearly and completely below with reference to the accompanying drawings. Apparently, the described embodiments are merely a part of embodiments of the present disclosure rather than all embodiments. Based on the embodiments of the present disclosure, all other embodiments obtained by those skilled in the art without creative effort fall within the protection scope of the present disclosure.

To make the objectives, technical solutions, and advantages of the present disclosure more clear, the present disclosure is further described in detail below with reference to the accompanying drawings. The described embodiments should not be construed as limiting the present disclosure. All other embodiments obtained by those of ordinary skill in the art without creative effort fall within the protection scope of the present disclosure.

In the following description, references are made to “some embodiments,” which describe a subset of all possible embodiments. It should be understood that “some embodiments” may be the same subset or different subsets of all possible embodiments, and may be combined with each other without conflict.

In the following description, the terms “first” and “second” are used merely to distinguish similar objects and do not represent any specific ordering of the objects. It should be understood that, where permitted, “first” and “second” may be interchanged in a specific order or sequence, such that the embodiments of the present disclosure described herein may be implemented in an order other than that illustrated or described herein.

Unless otherwise defined, all technical and scientific terms used herein have the same meanings as those commonly understood by those skilled in the art to which the present disclosure pertains. The terms used herein are only for the purpose of describing embodiments of the present disclosure and are not intended to limit the present disclosure.

It should be understood that, in various embodiments of the present disclosure, the numerical order of the steps of the respective processes does not imply an order of execution. The execution order of the respective processes should be determined based on their functions and internal logic, and should not be construed as imposing any limitation on the implementation of embodiments of the present disclosure.

Wireless sensing technology, as a communication technology, senses a surrounding environment through wireless signals, and may extract specific information or characterize events indicating occurrence of certain behaviors by detecting variations in certain characteristics of wireless signals (for example, phase, power, eigenvalues, or the like), so as to satisfy desired services or assist in achieving more efficient communication transmission. By utilizing wireless sensing technology, detection of whether objects such as persons or items appear in a sensing region may be implemented, health detection of objects appearing in the sensing region (for example, detection of heartbeat and respiration) may be implemented, and detection of accidental events occurring in the sensing region (for example, detection of a falling action) may be implemented.

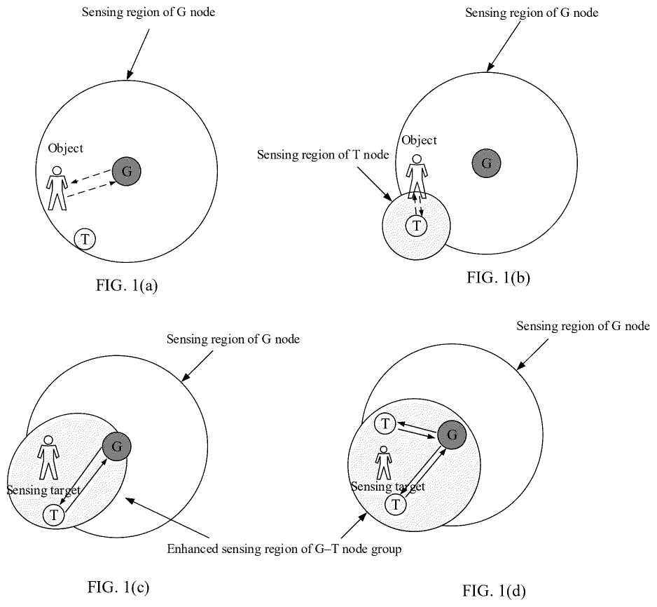

In wireless sensing technology, nodes are configured to operate in two roles: a management role node (referred to as a G node) and a managed role node managed by the G node (referred to as a T node). Nodes operating in either role each have a respective sensing region. As shown in FIG. 1(a), a G node performs sensing of an environment in a sensing region of the G node by self-transmitting and self-receiving sensing signals, such as determining whether an object enters the sensing region, and, when an object enters the sensing region, determining information such as a distance and an orientation of the object entering the sensing region. As shown in FIG. 1(b), a T node may also self-transmit and self-receive sensing signals, and, based on the self-transmitted and self-received sensing signals, determine whether an object appears in a sensing region of the T node, and, when an object enters the sensing region, determine a distance and an orientation of the object in the sensing region.

In practical applications, a sensing coverage of nodes in wireless sensing technology, including G nodes and T nodes, depends at least in part on a transmit power of the sensing signals.

As shown in FIGS. 1(c) and 1(d), in practical applications, an object appearing in the sensing region of the G node and the sensing region of the T node may be located in an intersecting region of the sensing regions of the two nodes. Because the intersecting region is located in both the sensing region of the G node and the sensing region of the T node, the intersecting region may be regarded as an enhanced sensing coverage region of a G-T node group (referred to as an enhanced sensing region). In the present disclosure, for an object appearing in the enhanced sensing region, accurate sensing of parameters such as a distance and an orientation of the object may be implemented by utilizing respective sensing of parameters such as the distance and the orientation of the object by the two types of nodes.

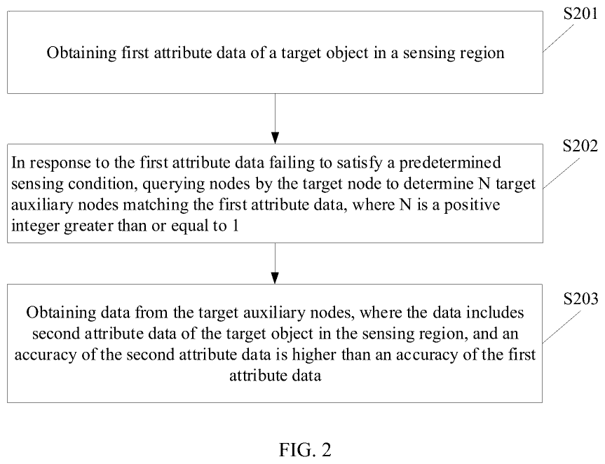

FIG. 2 illustrates a schematic flowchart of a method for improving recognition accuracy of object attributes in accordance with some embodiments of the present disclosure. The method is applied to a target node. The target node may be a G node or may be a T node.

As shown in FIG. 2, the method includes:

S201: obtaining first attribute data of a target object in a sensing region.

The target node implements sensing of an environment in the sensing region by self-transmitting and self-receiving sensing signals. When a target object such as a person or an item enters the sensing region, the target node obtains, by utilizing the sensing signals, a position of the target object in the sensing region.

In implementation, in response to the target object appearing in the sensing region of the target node, the first attribute data of the target object in the sensing region is obtained based on a sensing signal transmitted by the target node and a sensing signal received by the target node. Specifically, in wireless sensing technology, the target node performs an autocorrelation operation on two self-transmitted and self-received sensing signals, and based on an autocorrelation result, analyzes the position of the target object in the sensing region. For a detailed process, please refer to existing technology, and details are not described herein.

The first attribute data at least include a position (a distance and an orientation) of the target object in the sensing region of the target node. In addition, the first attribute data may further include a motion trajectory and/or a velocity of the target object in the sensing region.

S202: in response to the first attribute data failing to satisfy a predetermined sensing condition, querying nodes by the target node to determine N target auxiliary nodes matching the first attribute data, where N is a positive integer greater than or equal to 1.

Whether the first attribute data satisfies the predetermined sensing condition is determined. If the first attribute data fails to satisfy the predetermined sensing condition, S202 and S203 are performed to achieve accurate acquisition of attribute data of the target object. If the first attribute data satisfies the predetermined sensing condition, the first attribute data of the target object may be output.

In practical applications, wireless sensing services have certain requirements, such as an accuracy requirement for position information. The requirements of the wireless sensing services may be regarded as the predetermined sensing condition. If the first attribute data is able to satisfy the requirements of the wireless sensing services, the first attribute data may be regarded as satisfying the predetermined sensing condition; otherwise, the first attribute data is regarded as failing to satisfy the predetermined sensing condition.

In this step, when the first attribute data is unable to satisfy the requirements of the wireless sensing services, the target node queries nodes that are able to assist in sensing a position of the target object.

Taking the first attribute data being a position of the target object as an example, the target auxiliary nodes matching the first attribute data may include: among nodes queried by the target node, nodes whose positions are close to the position where the target object is located; or among the queried nodes, nodes whose sensing regions include the position where the target object is located. A number of the queried target auxiliary nodes may be one, or may be two or more, which is flexibly set according to specific situations.

When the target node is a G node serving as a management role, the target auxiliary nodes may be T nodes. When the target node is a T node, the target auxiliary nodes may be G nodes.

S203: obtaining data from the target auxiliary nodes, where the data includes second attribute data of the target object in the sensing region, and an accuracy of the second attribute data is higher than an accuracy of the first attribute data.

The target node configures sensing signals for the target auxiliary nodes, such as a type of the sensing signals (a G node or a T node), a transmit power of the sensing signals, a signal bandwidth, and the like. It may be understood that, because the target object is located in an enhanced sensing region of the target node and the target auxiliary nodes, an accuracy of calculating a position of the target object is positively correlated with a magnitude of the transmit power of the sensing signals. Therefore, compared with a transmit power of a sensing signal self-transmitted and self-received by the target node, a transmit power of a sensing signal configured by the target node for the target auxiliary nodes is larger. Compared with a position of the target object obtained by the target node utilizing a sensing signal with relatively small transmit power self-transmitted and self-received by the target node, a position of the target object obtained by the target auxiliary nodes utilizing a sensing signal having larger transmit power self-transmitted and self-received by the target auxiliary nodes has higher accuracy, thereby achieving accurate positioning of the target object.

In S201 to S203, the target node obtains the first attribute data of the target object in the sensing region, and, in response to the first attribute data failing to satisfy the predetermined sensing condition, queries N target auxiliary nodes matching the first attribute data and obtains second attribute data from the target auxiliary nodes, where the second attribute data is more accurate than the first attribute data, thereby achieving accurate acquisition of attribute data such as position.

In some embodiments of the present disclosure, the above-described obtaining data from the target auxiliary nodes, where the data includes the second attribute data of the target object in the sensing region, includes: obtaining the second attribute data of the target object in the sensing region; and obtaining third attribute data, based on the first attribute data and the second attribute data, where an accuracy of the third attribute data is higher than the accuracy of the first attribute data.

In implementation, an averaging operation or a weighted averaging operation may be performed on the first attribute data and the second attribute data, so as to obtain the third attribute data. Because the second attribute data is obtained based on a sensing signal having a large transmit power, an accuracy of the second attribute data is higher, and an accuracy of the third attribute data obtained based on the second attribute data having the high accuracy will also be higher than the accuracy of the first attribute data. Thus, by the target node and the target auxiliary nodes, accurate acquisition of attribute data such as a position is achieved.

In some embodiments of the present disclosure, after S203, the second attribute data may be output. Alternatively, in response to the first attribute data satisfying a preset sensing condition, the first attribute data is output. Outputting the first attribute data or the second attribute data for subsequent use is easy to apply.

In some embodiments of the present disclosure, the target node includes a first role node (a G node), and the second role nodes are T nodes. The above-described querying nodes, by the target node to determine N target auxiliary nodes matching the first attribute data, may include the following two exemplary cases:

Case 1: obtaining pre-configuration information of second role nodes located in the sensing region, where the pre-configuration information includes fixed position information of the second role nodes; and determining, based on the pre-configuration information, from the second role nodes located in the sensing region, N nodes matching the first attribute data to be the target auxiliary nodes.

Case 1 corresponds to a case where the T nodes queried by the target node are nodes with fixed positions. In such a case, the target node obtains position information of each T node with a fixed position located in the sensing region, and queries, from such nodes, T nodes that are able to assist the target node in sensing. This approach has good feasibility and strong practicality.

Case 2: initiating a query request to second role nodes located in the sensing region; determining, based on feedback information, from the second role nodes located in the sensing region, N nodes matching the first attribute data to be the target auxiliary nodes; where the feedback information includes real-time position information of the second role nodes in response to the query request.

Case 2 corresponds to a case where the T nodes queried by the target node are nodes with mobile positions. In such a case, the target node obtains real-time position information of each T node with a mobile position located in the sensing region, and queries, from such nodes, T nodes that are able to assist the target node in sensing. If the target auxiliary nodes are regarded as auxiliary sensing nodes, the foregoing solution achieves flexible selection of auxiliary sensing nodes and is suitable for application.

If the target node is regarded as an initial sensing node and the target auxiliary nodes are regarded as auxiliary sensing nodes, sensing, by the initial sensing node, of a position of the target object may be regarded as first-layer sensing, and sensing, by the auxiliary sensing nodes, of the position of the target object may be regarded as second-layer sensing. In this manner, the technical solution of the present disclosure may be regarded as a hierarchical sensing solution. Such a hierarchical sensing solution may enhance accuracy of obtaining attribute data.

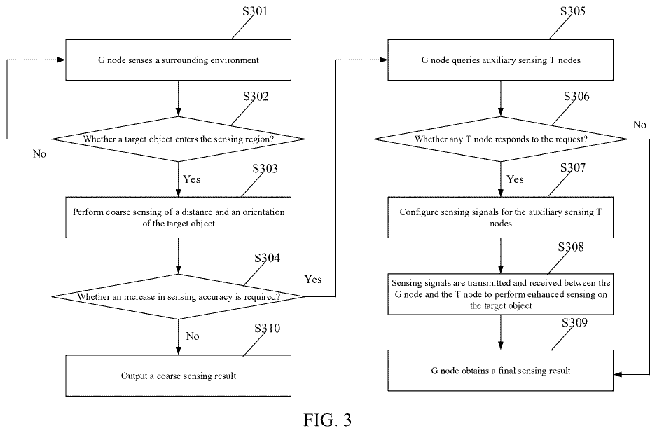

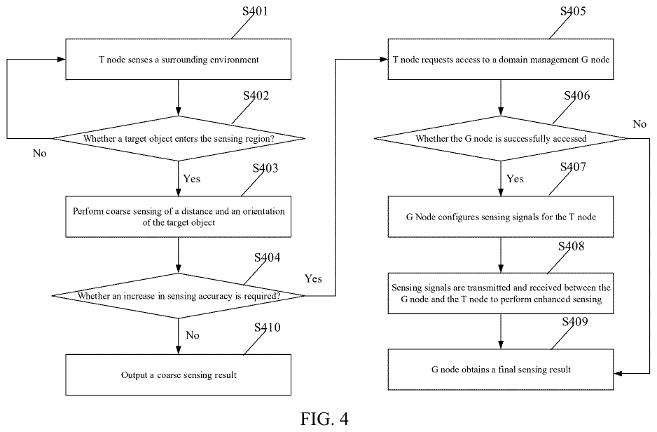

The technical solution of the present disclosure is described in detail below with reference to FIG. 3 by taking, as an example, application scenario one where a G node is used as the initial sensing node and a T node is used as the auxiliary sensing node.

In application scenario one, the target node is a G node, and the target auxiliary nodes are T nodes. A scenario where the G node performs initial sensing is suitable for a wireless sensing environment where the T nodes are required to save energy and, in most cases, remain in a silent state.

In application scenario one, a specific procedure and signaling interaction between the G node and the T node include the following steps and content:

S301: As a management node, a G node periodically self-transmits and self-receives sensing signals to sense a surrounding environment.

In this step, the G node performs periodic sensing of the surrounding environment in the sensing region through periodic self-transmitting and self-receiving of sensing signals.

The sensing signals may be physical layer reference signals in an existing wireless sensing system or may be enhanced physical layer reference signals. For example, based on an existing reference signal, an enhanced signal type may be designed to provide a larger bandwidth or configure more transmission periods for the enhanced signal. Alternatively, a reference signal specifically oriented toward sensing optimization may be designed, such as a sequence signal with better autocorrelation characteristics, to be used as the sensing signal.

S302: based on the self-transmitted and self-received sensing signals, the G node detects whether a target object enters the sensing region.

The G node performs autocorrelation on the self-transmitted and self-received sensing signals, and extracts a variation in channel state information from an autocorrelation result. If the variation is relatively large, it indicates that a target object such as a person or an item enters the sensing region, such that coarse sensing of the target object is performed and S303 is executed. If there is no variation or the variation is relatively small, it indicates that no target object enters the sensing region, and sensing of the surrounding environment is continued.

S303: based on the self-transmitted and self-received sensing signals, the G node performs coarse sensing of a distance and an orientation of the target object.

The process by which the G node obtains coarse position information of the target object through the self-transmitted and self-received sensing signals may refer to the related description and is not repeated herein.

As a single node, and considering limitations of sensing by a single node, the G node may obtain a sensing result with a relatively large error range. A possible position of the target object may be represented by a coarse position of the target object and a radius of a circle centered at the coarse position, for example, R=(pₑₛₜ, rₑₛₜ). Here, pₑₛₜ represents a position coordinate sensed by the G node, and rₑₛₜ represents a radius of a circle centered at the position coordinate. R represents a possible position of the target object in the sensing region.

Alternatively, a possible position of the target object in the sensing region may be represented by a closed polygonal region formed by a series of coordinate points, for example, R=(pₑₛₜ, p₁, p₂, . . . , pₖ), where pₑₛₜ represents a position coordinate sensed by the G node, and pₖ represents a coordinate value, in the sensing region, of an k-th node that surrounds pₑₛₜ and, together with pₑₛₜ, forms a closed polygon.

A size of a range of the possible position of the target object in the sensing region depends on a transmission configuration of the self-transmitted and self-received signals and a quality of received signals, such as a bandwidth of a transmitted signal, a signal transmit power, a signal-to-noise ratio (SNR) of a received signal, and the like.

S304: the G node determines whether an increase in sensing accuracy is required.

A wireless sensing service requirement specifies a sensing accuracy. Whether the coarse position of the target object satisfies the sensing accuracy of the wireless sensing service requirement is determined. If the coarse position fails to satisfy the required sensing accuracy, it is determined that a demand for increasing the sensing accuracy exists, and S305 is executed. If the coarse position satisfies the required sensing accuracy, it is determined that a demand for increasing the sensing accuracy does not exist, and S310 is executed to output a coarse sensing result without requiring participation of an auxiliary sensing node in sensing assistance.

Failure to satisfy the wireless sensing service requirement occurs, for example, if the wireless sensing service requires a higher position accuracy, or if, in addition to requiring a higher position accuracy, a motion trajectory and/or a velocity of the target object is also required, auxiliary sensing nodes (T nodes), are required to perform cooperative sensing.

S305: the G node queries T nodes.

The G node queries whether there are T nodes in proximity to the target object that are able to assist the G node in completing sensing. The nodes that assist the G node in completing sensing are required to have certain sensing capabilities, such as capabilities for transmitting and receiving sensing signals, signal processing capabilities, air-interface capabilities, and potential sensing resolution capabilities, and the like.

The T nodes located near the target object include two types: nodes with fixed positions and nodes with mobile positions. Different query schemes are adopted for these two types of nodes.

Query scheme 1: applicable to T nodes with fixed positions in the sensing region of the G node.

T nodes with sensing capabilities in the sensing region are required to be registered with the G node. The G node records pre-configuration information of these T nodes. The pre-configuration information represents sensing capability information of the T nodes and fixed positions of the T nodes in the sensing region of the G node. The sensing capabilities include a sensing signal type supported by the T node, a sensing signal transmission and reception mode, a supported sensing signal bandwidth, a maximum supported transmit power, a received signal sensitivity, and/or a number of antenna ports. Table 1 schematically illustrates a portion of the pre-configuration information of the T nodes in the sensing region.

TABLE 1

| T node | Sensing capability information | Position |
|---|---|---|
| T0 | Sensing signal type A; sensing signal “transmit”; | (x0, y0, z0) |
| | signal bandwidth B0; maximum transmit power P0; | |
| | number of antenna ports N0; . . . | |
| T1 | Sensing signal type A; sensing signal “transmit”; | (x1, y1, z1) |
| | signal bandwidth B1; maximum transmit power P1; | |
| | number of antenna ports N1; . . . | |
| T2 | Sensing signal type B; sensing signal “receive”; signal | (x2, y2, z2) |
| | bandwidth B2; reception signal sensitivity P2; number | |
| | of antenna ports N2; . . . | |
| . . . | . . . | . . . |

The G node determines T nodes located close to the coarse position of the target object in the sensing region to be target auxiliary nodes. Alternatively, T nodes that are located close to the coarse position of the target object and have a strong signal-to-noise ratio (SNR) of sensing signals and a small variation in channel state, are determined to be target auxiliary nodes.

Alternatively, the G node initiates an auxiliary sensing request to T nodes located close to the coarse position of the target object in the sensing region. Alternatively, the G node initiates an auxiliary sensing request to T nodes that are located close to the coarse position of the target object and have a strong SNR of sensing signals and a small variation in channel state. The T nodes feed back, based on their actual conditions, whether the T nodes are willing to serve as auxiliary sensing nodes to perform cooperative sensing.

Query scheme 2: applicable to mobile T nodes in the sensing region of the G node.

This scheme is suitable for T nodes that are movable in the sensing region of the G node. The G node sends a sensing service query request to mobile T nodes. A mobile T node receiving the sensing service query request feeds back its sensing capability information and real-time position.

Based on the feedback information of the mobile T nodes, the G node determines mobile T nodes, whose real-time positions are close to the target object, to be target auxiliary nodes. Alternatively, the G node determines mobile T nodes whose real-time positions are close to the target object and that have a strong SNR of sensing signals and small channel state variation, to be target auxiliary nodes.

Alternatively, the G node may initiate an auxiliary sensing request to mobile T nodes whose real-time positions are close to the target object. Alternatively, the G node may initiate an auxiliary sensing request to mobile T nodes whose real-time positions are close to the target object and that have a strong SNR of sensing signals and a small variation in channel state. The mobile T nodes feed back whether the mobile T nodes are willing to serve as auxiliary sensing nodes to perform cooperative sensing based on their actual conditions.

Taking initiating an auxiliary sensing request to nodes as an example, S306 is subsequently performed.

S306: the G node determines whether any T node responds to the auxiliary sensing request initiated by the G node.

A T node receiving the auxiliary sensing request may provide feedback regarding the auxiliary sensing request based on its actual condition, so as to indicate that the T node is willing to serve as an auxiliary sensing node of the G node to perform cooperative sensing.

Whether feedback regarding the auxiliary sensing request is received provides a certain degree of flexibility for determining whether a T node participates in auxiliary sensing.

It should be noted that the auxiliary sensing request initiated by the G node to T nodes may be sent to only one T node at a time, and auxiliary sensing requests may be sent sequentially to different T nodes. Alternatively, auxiliary sensing requests may be sent to a plurality of T nodes simultaneously, and no specific limitation is imposed in this regard.

If no T node feeds back to the G node that it is able to participate in auxiliary sensing, the G node may directly use the coarse position obtained in S303 as a result and output the result.

S307: the G node configures sensing signals for the auxiliary sensing nodes (T nodes).

The G node configures corresponding sensing signals for the T nodes participating in cooperative sensing, such as a sensing signal type, a signal bandwidth, and a transmit power, so as to ensure that the configured sensing signals are compatible with capabilities of the T nodes and are also able to satisfy the wireless sensing service requirement.

Compared with the transmit power of the sensing signal self-transmitted and self-received by the target node, the G node, within a capability range of the T nodes, configures sensing signals with relatively large transmit power for the T nodes as much as possible, so that the T nodes are able to detect the target object with a higher position accuracy.

S308: Sensing signals are transmitted and received between the G node and the T node to perform enhanced sensing on the target object.

The T nodes transmit sensing signals according to the configuration of the G node. The sensing signals transmitted by the T nodes may be received by the G node as received sensing signals. Based on the received sensing signals, the G node obtains a position of the target object in the sensing region of the G node again. It may be understood that, compared with the transmit power of the sensing signals used by the G node in S301, the transmit power of the sensing signals configured by the G node for the T nodes is larger. Accordingly, the power of the sensing signals transmitted by the T nodes and received by the G node is larger. By utilizing the sensing signals having larger power, accurate calculation of the position of the target object in the sensing region of the G node may be achieved.

Alternatively, the G node transmits sensing signals. The T nodes receives the sensing signals according to the configuration, calculate a position of the target object in the sensing region of the G node, and feeds back the position to the G node. Because the transmit power of the sensing signals configured by the G node for the T nodes is larger, accurate calculation of the position of the target object in the sensing region of the G node may be achieved by utilizing sensing signals having larger power.

In the foregoing solutions, the second attribute data includes the position obtained by utilizing sensing signals having larger power.

By utilizing sensing signals having larger power, a motion trajectory and/or a speed of a mobile object in the sensing region may also be calculated. The calculation process may refer to related descriptions and is not repeated herein.

It may be understood that the auxiliary sensing T nodes are nodes located close to the target object. From another perspective, the target object is located in a sensing region of the auxiliary sensing T nodes, and therefore is naturally located in an overlapping region of the sensing region of the auxiliary sensing T nodes and the sensing region of the G node. The overlapping region is a sensing-enhanced region. By utilizing the G node and the auxiliary sensing T nodes to jointly sense the target object in the sensing-enhanced region, compared with single-node sensing by the G node, more accurate position information of the target object is inevitably obtained.

S309: the G node obtains more accurate second attribute data of the target object in the sensing region.

As described with reference to S308, the G node may perform resolution or calculation on sensing signals having larger power to obtain a more accurate position. Alternatively, the G node receives a more accurate position calculated by the auxiliary sensing nodes based on sensing signals having larger power.

In addition, the G node may perform an averaging operation or a weighted averaging operation on the coarse position calculated in S303 and the position obtained by utilizing sensing signals having larger power, thereby obtaining position information that is more accurate than the foregoing coarse position. More accurate position information may be used as third attribute data.

The more accurate second attribute data or third attribute data of the target object in the sensing region may serve as a final sensing result obtained through cooperative sensing between the G-T nodes or auxiliary sensing by the target auxiliary nodes. If required, the G node may output the final sensing result for use by a sensing service requester that requests the final sensing result from the G node.

In application scenario one, based on related protocols of wireless sensing technology such as the SparkLink protocol, the SparkLink protocol may be updated. For example, reporting of node sensing capabilities (S305) may be added in a protocol air interface, querying whether a T node is willing to participate in auxiliary sensing (S306) may be added in the protocol, and two representation modes of a possible position of a target object in a sensing region (S303) may be defined in the protocol.

In general terms, in application scenario one, the G node achieves preliminary sensing of a target object in the sensing region by self-transmitting and self-receiving sensing signals, so as to obtain a relatively coarse sensing result. By querying auxiliary nodes (T nodes) with sensing capability located near the target object, and scheduling auxiliary T nodes that are willing to participate in auxiliary sensing to participate in enhanced sensing of the target object, a more accurate sensing result for the target object is obtained.

In application scenario one, hierarchical sensing is implemented by utilizing the G node and the T nodes. Such a hierarchical sensing solution may enhance accuracy of obtaining attribute data.

In some embodiments of the present disclosure, the target node includes a second role node, and the first attribute data is used to represent the position of the target object in the sensing region. Based on this, the above-described querying nodes, by the target node, to determine N target auxiliary nodes matching the first attribute data, includes: determining a target management node of the target node based on the first attribute data, where the target management node is a node that manages the target node and a sensing region of the target management node at least covers the position of the target object in the sensing region; when the target node accesses a communication domain where the target management node is located, sending a request to the target management node; and, when information fed back by the target management node in the communication domain in response to the request matches specified information, determining the target management node to be a target auxiliary node.

The foregoing solution corresponds to an application scenario, where a T node serves as an initial sensing node and a G node serves as an auxiliary sensing node (application scenario two). In application scenario two, the T node queries the G node, so that enhanced sensing of the target object is achieved through cooperation between the T node and the G node, thereby obtaining more accurate attribute data. The technical solution of the present disclosure is described in detail below with reference to FIG. 4.

Application scenario two is suitable for a case in a sensing environment where the G node is required to save energy, and the T node is able to self-transmit and self-receive sensing signals. In this scenario, after completing initial sensing, the T node is required to request access to the G node, and enhanced sensing is achieved through cooperation between the G node and the T node.

In application scenario two, a specific procedure and signaling interaction between the G node and the T node include the following steps and content.

S401: A T node periodically self-transmits and self-receives sensing signals to sense a surrounding environment.

In this step, the T node performs periodic sensing of the surrounding environment in a sensing region through periodic self-transmitting and self-receiving of sensing signals.

The sensing signals may be physical layer reference signals in an existing wireless sensing system, or may be enhanced physical layer reference signals. For example, based on an existing reference signal, an enhanced signal type may be designed to provide a larger bandwidth or configure more transmission periods for the enhanced signal. Alternatively, a reference signal specifically oriented toward sensing optimization may be designed, such as a sequence signal with better autocorrelation characteristics, to be used as the sensing signal.

S402: based on the self-transmitted and self-received sensing signals, the T node detects whether a target object enters the sensing region.

The T node performs autocorrelation on the self-transmitted and self-received sensing signals, and extracts variations in channel state information from an autocorrelation result. If the variation is relatively large, it indicates that a target object, such as a person or an item, enters the sensing region, thus coarse sensing of the target object is performed and S403 is executed. If there is no variation or the variation is relatively small, it indicates that no target object enters the sensing region, and sensing of the surrounding environment is continued.

S403: based on the self-transmitted and self-received sensing signals, the T node performs coarse sensing of a distance and an orientation of the target object.

A process by which the T node obtains coarse position information of the target object through the self-transmitted and self-received sensing signals may refer to the related description and is not repeated herein.

Considering the limitations of single-node sensing, the T node serving as a single node may obtain a sensing result with a relatively large error range. A possible position of the target object may be represented by a coarse position of the target object and a radius of a circle centered at the coarse position, for example, R=(pₑₛₜ, rₑₛₜ). Here, pₑₛₜ represents a position coordinate sensed by the T node, and rₑₛₜ represents a radius of a circle centered at the position coordinate. R represents a possible position of the target object in the sensing region.

Alternatively, the possible position of the target object in the sensing region may be represented by a closed polygonal region formed by a series of coordinate points, for example, R=(pₑₛₜ, p₁, p₂, . . . , pₖ), where pₑₛₜ represents a position coordinate sensed by the T node, and pₖ represents a coordinate value, in the sensing region, of an k-th node that surrounds pₑₛₜ and together with pₑₛₜ forms a closed polygon.

A size of a range of the possible position of the target object in the sensing region depends on transmission configuration of the self-transmitted and self-received sensing signals and quality of received signals, such as a signal bandwidth, a signal transmit power, and a signal-to-noise ratio of a received signal.

S404: the T node determines whether there is a need to increase sensing accuracy.

Wireless sensing service requirements specify a sensing accuracy. It is determined whether the coarse position of the target object satisfies the sensing accuracy of the wireless sensing service requirements. If the coarse position fails to satisfy the required sensing accuracy, it is determined that there is a requirement to increase sensing accuracy, and S405 is executed. If the coarse position satisfies the required sensing accuracy, it is determined that there is no requirement to increase sensing accuracy, S410 is executed, and a coarse sensing result is output, without requiring participation of auxiliary sensing nodes in sensing assistance.

Failing to satisfy the wireless sensing service requirements includes, for example: the wireless sensing service requires higher positioning accuracy; or, in addition to higher positioning accuracy, a motion trajectory and/or a speed of the target object is required, in which case cooperative sensing by an auxiliary sensing node (G node) is required.

If the requirements of the wireless sensing services cannot be satisfied, for example, if the wireless sensing services require higher position accuracy, or if, in addition to higher position accuracy, a motion trajectory and/or a speed of the target object is also required, in which case cooperative sensing by an auxiliary sensing node (G node) is required.

S405: the T node requests access to a domain management G node.

A management node, whose sensing region covers the sensing region of the T node and also covers the coarse position of the target object, is queried. The queried management node, in terms of geographic location, has a sensing region that is required to cover both the sensing region of the T node and the coarse position of the target object. In terms of role, the queried management node is a node configured to manage the T node.

The T node, serving as a node within a communication domain where the management node is located, accesses the communication domain, and based on the communication domain, initiates an (auxiliary sensing) request to the G node, so as to request the G node to perform auxiliary sensing.

During the access process, an indication of information related to participation in sensing, such as sensing capabilities of a node and whether the node participates in sensing, may be added at a signaling level of the communication domain,

S406: determine whether the G node responds to the auxiliary sensing request (determine whether the G node is successfully accessed).

When the G node receives the (auxiliary sensing) request from the T node, the G node determines, based on its actual condition, whether to accept the request. If a communication service load of the G node is relatively heavy and required sensing resources are unable to satisfy auxiliary sensing requirements, the G node may reject the request. If the communication service load of the G node is relatively light, the G node may return signaling indicating successful access and agreement to perform auxiliary sensing.

If the G node feeds back signaling indicating agreement to perform auxiliary sensing, it is considered that the auxiliary sensing request is responded to and that the G node is successfully accessed. If the G node feeds back signaling indicating rejection of the request, it is determined that the auxiliary sensing request is responded to and that the G node is not successfully accessed. If the G node does not provide feedback in response to the (auxiliary sensing) request within a preset time, it is determined that the auxiliary sensing request is not responded to and that the G node is not successfully accessed.

S407: The G node configures sensing signals for the T node (the initial sensing node).

The G node configures corresponding sensing signals for the initial sensing node based on wireless sensing service requirements and sensing capabilities of the initial sensing T node, such as a sensing signal type, a signal bandwidth, and a transmit power, so as to ensure that the configured sensing signals are able to match capabilities of the T node and are also able to satisfy the wireless sensing service requirements.

Here, compared with the transmit power of self-transmitted and self-received sensing signals by the initial sensing T node, the G node, within a capability range of the T node, configures a transmit power for the T node that is as large as possible within the capability range of the T node, so that the T node is able to detect the target object with a more accurate position.

S408: sensing signals are transmitted and received between the G node and the T node to perform enhanced sensing on the target object.

The T node transmits a sensing signal according to the configuration of the G node. The sensing signal of the T node may serve as a self-received sensing signal and be received by the G node. Based on the received sensing signal, the G node again obtains the position of the target object in the sensing region of the G node. It may be understood that, compared with transmit power of the sensing signals used by the G node in S401, the transmit power of the sensing signal configured by the G node for the T node is larger. Accordingly, the power of the sensing signal of the T node received by the G node is larger. By utilizing the sensing signal with larger power, accurate calculation of the position of the target object in the sensing region of the G node may be achieved.

Alternatively, the G node transmits a sensing signal, and the T node receives the sensing signal according to the configuration, calculates a position of the target object in the sensing region of the G node, and feeds back the position to the G node. Because the power of the sensing signal configured by the G node for the T node is larger, accurate calculation of the position of the target object in the sensing region of the G node may be achieved by utilizing the sensing signal with larger power.

In the foregoing solutions, the second attribute data includes a position obtained by utilizing a sensing signal having a larger power.

By utilizing the sensing signal having the larger power, a motion trajectory and/or a speed of a mobile object in the sensing region may also be calculated.

It may be understood that the sensing region of the G node covers a position where the target object is located and also covers the sensing region of the T node. From another perspective, the target object is located in an overlapping region of the initial sensing T node and the G node. The overlapping region is a sensing-enhanced region. By jointly sensing the target object in the sensing-enhanced region utilizing the initial sensing T node and the G node, compared with single-node sensing by the T node, more accurate position information of the target object is inevitably obtained.

S409: the G node obtains more accurate (second) attribute data of the target object in the sensing region.

As shown with reference to S408, the G node may perform resolution or calculation on the sensing signal having the larger power to obtain a more accurate position. Alternatively, the G node may receive a more accurate position calculated by the auxiliary sensing node based on the sensing signal having the larger power.

In addition, the G node may perform an averaging operation or a weighted averaging operation on the coarse position calculated in S403 and the position obtained by utilizing the sensing signal having the larger power, thereby obtaining position information that is more accurate than the foregoing coarse position (the more accurate position information may be used as third attribute data).

The more accurate (second or third) attribute data of the target object in the sensing region may serve as a final sensing result obtained through cooperative sensing between the G node and the T node or through auxiliary sensing by target auxiliary nodes. If necessary, the G node may output the final sensing result for use by a sensing service requester that requests the final sensing result from the G node.

In application scenario two, based on related protocols of wireless sensing technology such as the SparkLink protocol, the SparkLink protocol may be updated. For example, an auxiliary sensing request access by a sensing node (S405) may be added to an air interface, and a protocol for indicating whether the G node responds to an auxiliary sensing request (S406) may be added.

In general terms, in application scenario two, the T node achieves preliminary sensing of a target object in the sensing region by self-transmitting and self-receiving sensing signals, so as to obtain a relatively coarse sensing result. By querying an auxiliary node (the G node) and by combining the T node and the G node, enhanced sensing of the target object is realized, and a more accurate sensing result for the target object is obtained.

In application scenario two, hierarchical sensing is implemented by utilizing the G node and the T node. Such a hierarchical sensing solution may enhance the accuracy of obtained attribute data.

In some embodiments of the present disclosure, the target node includes a first role node (G node) and at least one second role node (T node). That is, initial sensing nodes include the G node and the at least one T node. Based on this, the above-described querying nodes by the target node to determine N target auxiliary nodes that match the first attribute data may be implemented by the following two approaches.

Approach one: obtaining pre-configuration information of M second role nodes located in the sensing region other than the at least one second role node, where the pre-configuration information includes fixed position information of the M second role nodes, and M is a positive integer greater than or equal to 1; and determining, based on the pre-configuration information of the M second role nodes, from the M second role nodes, N nodes that match the first attribute data to be the target auxiliary nodes.

In approach one, the situation involves a case where the T nodes queried by the target node are fixed-position nodes. In this case, the target node obtains position information of each T node with a fixed position located in the sensing region, and queries, from such nodes, T nodes that are able to assist the target node in sensing. This approach has good feasibility and strong practicality.

Approach two: initiating a query request to L second role nodes located in the sensing region other than the at least one second role node, where L is a positive integer greater than or equal to 1; determining, based on feedback information of the L second role nodes, from the L second role nodes, N nodes that match the first attribute data to be the target auxiliary nodes, where the feedback information includes real-time position information of the second role nodes in response to the query request.

In approach two, the situation involves a case where the T nodes queried by the target node are mobile nodes. In this case, the target node obtains real-time position information of each T node with a mobile position located in the sensing region, and queries, from such nodes, T nodes that are able to assist the target node in sensing. This approach enables flexible selection of auxiliary sensing nodes, thereby achieving accurate acquisition of attribute data of the target object.

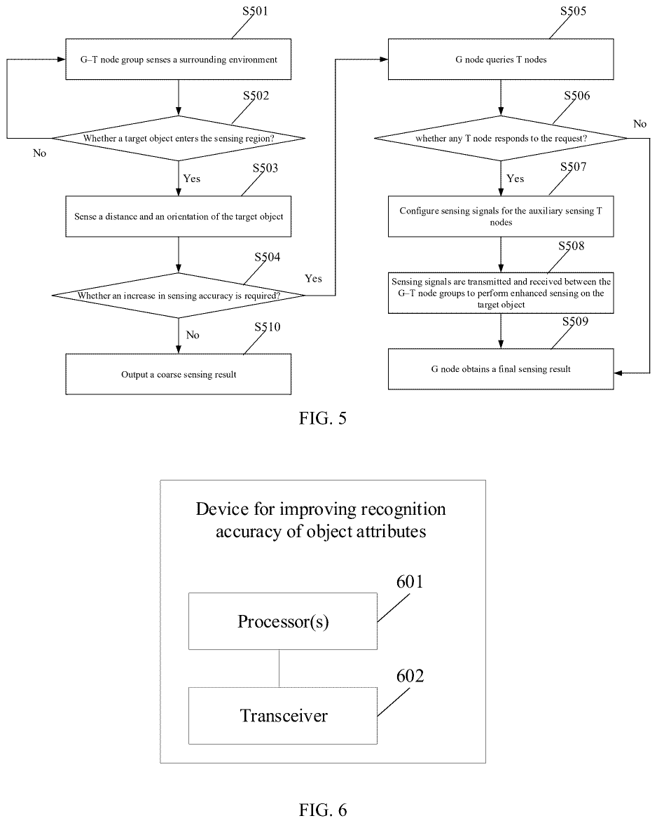

The foregoing solution corresponds to an application case where a G node and one or more T nodes serve as initial sensing nodes, and one or more other T nodes serve as auxiliary sensing nodes (hereinafter referred to as application scenario three). For clarity, in application scenario three, one or more T nodes that participate in an initial sensing stage together with the G node are referred to as one or more initial sensing T nodes, whereas one or more other T nodes that are subsequently queried and selected to assist in enhanced sensing are referred to as one or more auxiliary sensing T nodes, and the initial sensing T nodes and the auxiliary sensing T nodes belong to different sets of T nodes. In application scenario three, the G node queries the auxiliary sensing T nodes, so that enhanced sensing of the target object is achieved through cooperation between the auxiliary sensing T nodes and the initial sensing nodes (a G-T node group), thereby obtaining more accurate attribute data of the target object. The technical solution of the present disclosure is described in detail below with reference to FIG. 5.

In application scenario three, the initial sensing nodes include the G node and the initial sensing T nodes. The number of the initial sensing T nodes among the initial sensing nodes may be one or may be two or more.

In application scenario three, that is, in a scenario where the initial sensing nodes are a G-T node group (a combination of a G node and at least one T node), the solution is suitable for a sensing environment where one or at least two T nodes have already been configured for the G node, and sensing of a surrounding environment is performed through transmission and reception of sensing signals by the G node and the initial sensing T nodes. However, in such a scenario, additional T nodes are requested to access auxiliary sensing to achieve enhanced sensing, thereby improving sensing performance. Application scenario three differs from application scenario one (where the initial sensing node is a G node) and application scenario two (where the initial sensing node is a T node) in that the initial sensing nodes are a G-T node group, and a request for more other T nodes is still needed to implement cooperative sensing.

In application scenario three, a specific procedure and interaction signaling content include the following steps and corresponding content.

S501: a G-T node group periodically transmits and receives sensing signals to perform sensing of a surrounding environment.

The G node periodically transmits and receives sensing signals in its sensing region, and the initial sensing T nodes periodically transmit and receive sensing signals in their sensing regions, so as to sense the environment in the sensing region. Alternatively, the G node periodically transmits sensing signals in an overlapping region of sensing regions of the G node and the initial sensing T nodes, and the initial sensing T nodes periodically receive the sensing signals as self-received signals, thereby achieving periodic environment sensing by the G-T node group in the sensing region. Alternatively, the initial sensing T nodes periodically transmit sensing signals in an overlapping region of sensing regions of the G node and the initial sensing T nodes, and the G node receives the sensing signals, thereby achieving periodic environment sensing by the G-T node group in the sensing region.

The sensing signals may include physical layer reference signals in an existing wireless sensing system, and may also include enhanced physical layer reference signals. For details, reference may be made to the foregoing related description, and details are not repeated herein.

S502: at least one node in the G-T node group detects whether a target object enters the sensing region.

This step may be performed by the G node or by the initial sensing T nodes, to determine whether a target object enters a sensing coverage region. Taking the G node performing this step as an example, the G node performs autocorrelation on self-transmitted and self-received sensing signals, and extracts variations in channel state information from an autocorrelation result. If the variation is relatively large, it indicates that a target object such as a person or an item enters the sensing region, such that coarse sensing of the target object is performed and S503 is executed. If there is no variation or the variation is relatively small, it indicates that no target object enters the sensing region, and sensing of the surrounding environment is continued.

S503: at least one node in the G-T node group senses a distance and an orientation of the target object.

This step may be performed by the G node, the initial sensing T nodes, or the G-T node group. A process by which the G node, the initial sensing T nodes, or the G-T node group obtains coarse position information of the target object through self-transmitted and self-received sensing signals may refer to the related description and is not repeated herein.

S504: at least one node in the G-T node group determines whether it is required to increase or improve sensing accuracy.

Taking the G node performing this step as an example, it is determined whether the coarse position satisfies sensing accuracy required by wireless sensing service requirements. If the coarse position fails to satisfy the required sensing accuracy, it is determined that there is a requirement to increase sensing accuracy, and S505 is executed. If the coarse position satisfies the required sensing accuracy, it is determined that there is no requirement to increase sensing accuracy, S510 is executed, and the coarse sensing result (the coarse position) is output, without requiring participation of auxiliary sensing nodes in sensing assistance.

S505: the G node queries other T nodes in the sensing region other than the initial sensing T nodes.

T nodes located near the target object include two types: nodes with fixed positions and nodes with mobile positions. Different query schemes are used for these two types of nodes.

Query scheme 1: applicable to T nodes with fixed positions in the sensing region of the G node.

T nodes with sensing capability in the sensing region are required to be registered with the G node. The G node records pre-configuration information of these T nodes, where the pre-configuration information represents sensing capability information of the T nodes and fixed positions of the T nodes in the sensing region of the G node.

Other T nodes in the sensing region, other than the initial sensing T nodes, whose distances to the coarse position of the target object are relatively small, are determined to be target auxiliary nodes by the G node. Alternatively, other T nodes in the sensing region, other than the initial sensing T nodes, that are close to the coarse position, have a strong signal-to-noise ratio (SNR) of sensing signals, and exhibit relatively small channel state variations are determined to be target auxiliary sensing T nodes.

Alternatively, the G node may initiate an auxiliary sensing request to other T nodes in the sensing region, other than the initial sensing T nodes, whose distances to the coarse position of the target object are relatively small. Alternatively, the G node may initiate an auxiliary sensing request to other T nodes in the sensing region, other than the initial sensing T nodes, that are located close to the coarse position of the target object, have a strong signal-to-noise ratio (SNR) of sensing signals, and exhibit relatively small channel state variations. The other T nodes feedback whether they are willing to serve as the auxiliary sensing nodes to perform cooperative sensing based on their own status.

Query scheme 2: applicable to mobile T nodes in the sensing region of the G node.

This scheme is suitable for T nodes that are movable in the sensing region of the G node. The G node sends a (sensing service) query request to mobile T nodes in the sensing region other than the initial sensing T nodes. Upon receiving the sensing service query request, a mobile T node feeds back its sensing capability information and real-time position.

Based on feedback information of the mobile T nodes, the G node determines mobile T nodes whose real-time positions are close to the target object, to be the target auxiliary nodes. Alternatively, the G node determines mobile T nodes, whose real-time positions are close to the target object and that have a strong signal-to-noise ratio (SNR) of sensing signals and small channel state variations, to be the target auxiliary nodes.

Alternatively, the G node may initiate an auxiliary sensing request to mobile T nodes whose real-time positions are close to the target object. Alternatively, the G node may initiate an auxiliary sensing request to mobile T nodes whose real-time positions are close to the target object and that have a strong SNR of sensing signals and small channel state variations. Each of the mobile T nodes feeds back, based on its actual condition, whether the mobile T node is willing to serve as an auxiliary sensing node to perform cooperative sensing.

Taking initiating an auxiliary sensing request to nodes as an example, S506 is subsequently performed.

S506: the G node determines whether any T node responds to the auxiliary sensing request.

Upon receiving the auxiliary sensing request, a T node may, based on its actual condition, provide feedback regarding the auxiliary sensing request to indicate that the T node is willing to serve as an auxiliary sensing node of the G node to perform cooperative sensing.

By providing feedback in response to the auxiliary sensing request indicating whether the T node may participate in auxiliary sensing, flexibility is provided for the T node with respect to participation in auxiliary sensing.

It should be noted that when the G node initiates auxiliary sensing requests to T nodes, the G node may send an auxiliary sensing request to only one T node at a time, sequentially requesting different T nodes. Alternatively, the G node may send auxiliary sensing requests to multiple T nodes simultaneously, and no specific limitation is imposed in this regard.

If no T node feeds back to the G node that it is willing to participate in auxiliary sensing, the G node may directly use the coarse position obtained in S503 as a result and output the result.

S507: the G node configures sensing signals for auxiliary sensing T nodes.

Here, the G node configures corresponding sensing signals for the auxiliary sensing T nodes participating in cooperative sensing other than the initial sensing T nodes, such as sensing signal types, signal bandwidth, and transmit power, so as to ensure that the configured sensing signals are able to match capabilities of the T nodes and are also able to satisfy wireless sensing service requirements.

Specifically, compared with transmit power of self-transmitted and self-received sensing signals of the target node, the G node, within a capability range of the auxiliary sensing T nodes participating in cooperative sensing, configures sensing signals with relatively large transmit power for the auxiliary sensing T nodes as much as possible, so that the auxiliary sensing T nodes are able to detect the target object with higher position accuracy.

S508: sensing signals are transmitted and received among G-T node groups to perform enhanced sensing of the target object.

In this step, a node group formed by the G node and the initial sensing T nodes, and another G-T node group formed by the G node and the auxiliary sensing T nodes, transmit and receive sensing signals, so as to achieve enhanced sensing of the target object.

The auxiliary sensing T nodes participating in cooperative sensing transmit sensing signals according to the configuration of the G node. Sensing signals transmitted by T nodes may be received by the G node as received sensing signals. Based on the received sensing signals, the G node again obtains a position of the target object in the sensing region of the G node. It may be understood that, compared with transmit power of the sensing signals used by the G node in S501 and transmit power of the sensing signals of the initial sensing T nodes, transmit power of the sensing signals configured by the G node for the auxiliary sensing T nodes participating in cooperative sensing is larger. Accordingly, power of the sensing signals transmitted by such auxiliary sensing T nodes and received by the G node is larger. By utilizing sensing signals having larger power, accurate calculation of the position of the target object in the sensing region of the G node may be achieved.

Alternatively, the G node may transmit sensing signals, and the auxiliary sensing T nodes participating in cooperative sensing may receive the sensing signals according to the configuration, calculate a position of the target object in the sensing region of the G node, and feed back the position to the G node. Because transmit power of the sensing signals configured by the G node for the auxiliary sensing T nodes participating in cooperative sensing is larger, accurate calculation of the position of the target object in the sensing region of the G node may be achieved by utilizing sensing signals having larger power.

In the foregoing scheme, the second attribute data includes position information obtained by utilizing sensing signals having larger power.

By utilizing sensing signals having larger power, a motion trajectory and/or a speed of a mobile object in the sensing region may also be calculated. The calculation process may refer to related descriptions and is not repeated herein.

It may be understood that the auxiliary sensing T nodes are nodes located close to the target object. From another perspective, the target object is located in sensing regions of the auxiliary sensing T nodes, and therefore the target object is naturally located in an overlapping region of the sensing regions of the auxiliary sensing T nodes and the sensing region of the G node. The overlapping region serves as a sensing-enhanced region. By utilizing a node group formed by the G node and the initial sensing T nodes and another node group formed by the G node and the auxiliary sensing T nodes participating in cooperative sensing, that is, by utilizing two node groups to jointly sense the target object in the sensing-enhanced region, compared with sensing by a single node group, more accurate position information of the target object is inevitably obtained.

S509: the G node obtains more accurate (second) attribute data of the target object in the sensing region.

As shown in S508, the G node may perform resolution or calculation on sensing signals having larger power to obtain a more accurate position. Alternatively, the G node may receive a more accurate position calculated by auxiliary sensing nodes based on sensing signals having larger power.

In addition, the G node may perform an averaging operation or a weighted averaging operation on the coarse position calculated in S503 and the position obtained by utilizing sensing signals having larger power, thereby obtaining position information that is more accurate than the foregoing coarse position (the more accurate position information may be used as third attribute data).

The more accurate (second or third) attribute data of the target object in the sensing region may be used as a final sensing result obtained through cooperative sensing among the G-T node groups. If required, the G node may output the final sensing result for use by a sensing service requester that requests the final sensing result from the G node.

In application scenario three, based on related protocols of wireless sensing technology such as the SparkLink protocol, the SparkLink protocol may be updated. For example, reporting of node sensing capabilities (S505) may be added in an air interface, and querying whether other T nodes in the sensing region other than the initial sensing T nodes are willing to participate in auxiliary sensing (S506) may be added.

From the above technical solutions, it can be seen that the present disclosure provides a solution for designing interaction signaling among different nodes based on the SparkLink protocol, with an objective of supporting hierarchical sensing of a target object in a sensing region. Such hierarchical sensing is reflected in that initial sensing nodes perform coarse sensing, and target auxiliary nodes perform cooperative sensing with the initial sensing nodes. Compared with sensing results obtained by the initial sensing nodes, which are relatively coarse, cooperative sensing between the target auxiliary nodes and the initial sensing nodes is able to obtain more refined or more accurate results.

In summary, in the present disclosure, a target node performs preliminary sensing of a target object in a sensing region by self-transmitted and self-received sensing signals, so as to obtain a relatively coarse sensing result. Based on the coarse sensing result, target auxiliary nodes capable of participating in cooperative sensing are queried. Based on coordination between the target node and the target auxiliary nodes, or coordination among node groups, enhanced sensing is performed on the target object to obtain a more accurate sensing result, such as by increasing sensing accuracy.

Some embodiments of the present disclosure provide a device for improving recognition accuracy of object attributes. As illustrated in FIG. 6, the device includes:
a processor 601, configured to: obtain first attribute data of a target object in a sensing region, and, in response to the first attribute data failing to satisfy a predetermined sensing condition, query nodes to determine N target auxiliary nodes matching the first attribute data, where N is a positive integer greater than or equal to 1; and
a transceiver 602, configured to obtain data from the target auxiliary nodes, where the data includes second attribute data of the target object in the sensing region, and accuracy of the second attribute data is higher than accuracy of the first attribute data.

In some embodiments of the present disclosure, the target node includes a first role node. The processor 601 is configured to:
obtain pre-configuration information of second role nodes located in the sensing region, where the pre-configuration information includes fixed position information of the second role nodes; and
determine, based on the pre-configuration information, from the second role nodes located in the sensing region, N nodes matching the first attribute data to be the target auxiliary nodes.

In some embodiments of the present disclosure, the target node includes a first role node. The processor 601 is configured to:
initiate a query request to second role nodes located in the sensing region; and
determine, based on feedback information, from the second role nodes located in the sensing region, N nodes matching the first attribute data to be the target auxiliary nodes, where the feedback information includes real-time position information of the second role nodes in response to the query request.

In some embodiments of the present disclosure, the target node includes a second role node, and the first attribute data is used to represent a position of the target object in the sensing region. The processor 601 is configured to:
determine, based on the first attribute data, a target management node of the target node, where the target management node is a node that manages the target node, and a sensing region of the target management node is required to at least cover the position of the target object in the sensing region;
when the target node accesses a communication domain where the target management node is located, send a request to the target management node; and
when information fed back by the target management node in the communication domain in response to the request matches specified information, determine the target management node to be a target auxiliary node.

In some embodiments of the present disclosure, the target node includes a first role node and at least one second role node. The processor 601 is configured to:
obtain pre-configuration information of M second role nodes located in the sensing region other than the at least one second role node, where the pre-configuration information includes fixed position information of the M second role nodes, and M is a positive integer greater than or equal to 1; and
determine, based on the pre-configuration information of the M second role nodes, from the M second role nodes, N nodes matching the first attribute data to be the target auxiliary nodes.

In some embodiments of the present disclosure, the target node includes a first role node and at least one second role node. The processor 601 is configured to:
initiate a query request to L second role nodes located in the sensing region other than the at least one second role node, where L is a positive integer greater than or equal to 1;
determine, based on feedback information of the L second role nodes, from the L second role nodes, N nodes matching the first attribute data to be the target auxiliary nodes, where the feedback information includes real-time position information of the second role nodes in response to the query request.

In some embodiments of the present disclosure, the transceiver 602 is configured to:
obtain second attribute data of the target object in the sensing region; and
obtain third attribute data, based on the first attribute data and the second attribute data, where accuracy of the third attribute data is higher than accuracy of the first attribute data.

In some embodiments of the present disclosure, the processor 601 is configured to:
in response to a target object appearing in the sensing region of the target node, obtain first attribute data of the target object in the sensing region based on a sensing signal transmitted by the target node and a sensing signal received by the target node.

In some embodiments of the present disclosure, the device includes an output unit, configured to:
output the second attribute data; or
in response to the first attribute data satisfying a preset sensing condition, output the first attribute data.

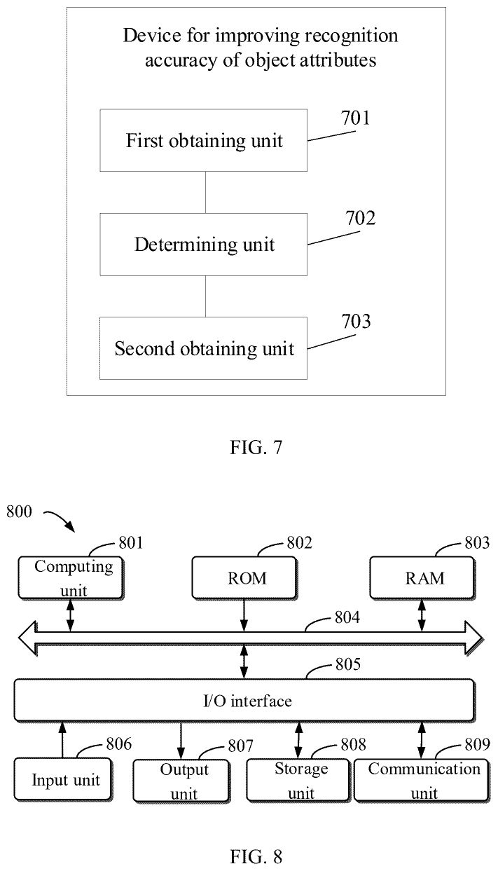

Some embodiments of the present disclosure further provide another device for improving recognition accuracy of object attributes. As illustrated in FIG. 7, the device includes:
a first obtaining unit 701, configured to obtain first attribute data of a target object in a sensing region;
a determining unit 702, configured to, in response to the first attribute data failing to satisfy a predetermined sensing condition, query nodes to determine N target auxiliary nodes matching the first attribute data, where N is a positive integer greater than or equal to 1; and
a second obtaining unit 703, configured to obtain data from the target auxiliary nodes, where the data includes second attribute data of the target object in the sensing region, and accuracy of the second attribute data is higher than accuracy of the first attribute data.

In some embodiments of the present disclosure, the target node includes a first role node. The determining unit 702 is configured to:
obtain pre-configuration information of second role nodes located in the sensing region, where the pre-configuration information includes fixed position information of the second role nodes; and
determine, based on the pre-configuration information, from the second role nodes located in the sensing region, N nodes matching the first attribute data to be the target auxiliary nodes.

In some embodiments of the present disclosure, the target node includes a first role node. The determining unit 702 is configured to:
initiate a query request to second role nodes located in the sensing region; and
determine, based on feedback information, from the second role nodes located in the sensing region, N nodes matching the first attribute data as the target auxiliary nodes, where the feedback information is real-time position information of the second role nodes in response to the query request.

In some embodiments of the present disclosure, the target node includes a second role node, and the first attribute data is used to represent a position of the target object in the sensing region. The determining unit 702 is configured to:
determine, based on the first attribute data, a target management node of the target node, where the target management node is a node that manages the target node, and a sensing region of the target management node is required to at least cover the position of the target object in the sensing region;
when the target node accesses a communication domain where the target management node is located, send a request to the target management node; and
when information fed back by the target management node in the communication domain in response to the request matches specified information, determine the target management node as a target auxiliary node.

In some embodiments of the present disclosure, the target node includes a first role node and at least one second role node. The determining unit 702 is configured to:
obtain pre-configuration information of M second role nodes located in the sensing region other than the at least one second role node, where the pre-configuration information includes fixed position information of the M second role nodes, and M is a positive integer greater than or equal to 1; and
determine, based on the pre-configuration information of the M second role nodes, from the M second role nodes, N nodes matching the first attribute data to be the target auxiliary nodes.

In some embodiments of the present disclosure, the target node includes a first role node and at least one second role node. The determining unit 702 is configured to:
initiate a query request to L second role nodes located in the sensing region other than the at least one second role node, where L is a positive integer greater than or equal to 1; and
determine, based on feedback information of the L second role nodes, from the L second role nodes, N nodes matching the first attribute data as the target auxiliary nodes, where the feedback information is real-time position information of the second role nodes in response to the query request.

In some embodiments of the present disclosure, the second obtaining unit 703 is configured to:
obtain second attribute data of the target object in the sensing region; and
obtain third attribute data based on the first attribute data and the second attribute data, where accuracy of the third attribute data is higher than accuracy of the first attribute data.

In some embodiments of the present disclosure, the first obtaining unit 701 is configured to:
in response to a target object appearing in the sensing region of the target node, obtain first attribute data of the target object in the sensing region based on sensing signals received by the target node.

In some embodiments of the present disclosure, the device further includes an output unit, configured to:
output the second attribute data; or
in response to the first attribute data satisfying a preset sensing condition, output the first attribute data.

It should be noted that, for the two devices for improving recognition accuracy of object attributes provided in the embodiments of the present disclosure, principles for solving problems are similar to those of the method for improving recognition accuracy of object attributes described above. Accordingly, implementation processes and implementation principles of the devices for improving recognition accuracy of object attributes may refer to the implementation processes and implementation principles of the corresponding method described above, and repeated descriptions are omitted.

According to some embodiments of the present disclosure, the present disclosure further provides an electronic device and a readable storage medium.

The electronic device includes at least one processor, and a memory communicatively connected to the at least one processor, where the memory stores instructions executable by the at least one processor, and the instructions, when executed by the at least one processor, cause the at least one processor to perform the method for improving recognition accuracy of object attributes described above.

With respect to a non-transitory computer-readable storage medium storing computer instructions, the computer instructions are used to cause a computer to perform the method for improving recognition accuracy of object attributes described above.

FIG. 8 illustrates a schematic block diagram of an example electronic device 800 that may be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital assistants, cellular phones, smart phones, wearable devices, and other similar computing devices. The components shown herein, their connections and relationships, and their functions are provided merely as examples, and are not intended to limit implementations of the present disclosure described and/or claimed herein.

As shown in FIG. 8, the device 800 includes a computing unit 801. The computing unit 801 is configured to perform various appropriate actions and processing according to computer programs stored in a read-only memory (ROM) 802 or computer programs loaded from a storage unit 808 into a random access memory (RAM) 803. The RAM 803 may also store various programs and data required for operation of the device 800. The computing unit 801, the ROM 802, and the RAM 803 are connected to one another through a bus 804. An input/output (I/O) interface 805 is also connected to the bus 804.

A plurality of components in the device 800 are connected to the I/O interface 805, including: an input unit 806, such as a keyboard, a mouse, or the like; an output unit 807, such as various types of displays, speakers, or the like; a storage unit 808, such as a magnetic disk, an optical disk, or the like; and a communication unit 809, such as a network interface card, a modem, a wireless communication transceiver, or the like. The communication unit 809 allows the device 800 to exchange information and/or data with other devices through a computer network such as the Internet and/or various telecommunication networks.

The computing unit 801 may be various general-purpose and/or special-purpose processing components with processing and computing capabilities. Examples of the computing unit 801 include, but are not limited to, a central processing unit (CPU), a graphics processing unit (GPU), various dedicated artificial intelligence (AI) computing chips, various computing units for running machine learning model algorithms, a digital signal processor (DSP), and any suitable processor, controller, microcontroller, or the like. The computing unit 801 executes the methods and processes described above, such as the method for improving recognition accuracy of object attributes. For example, in some embodiments of the present disclosure, the method for improving recognition accuracy of object attributes may be implemented as a computer software program tangibly embodied in a machine-readable medium, such as the storage unit 808. In some embodiments of the present disclosure, part or all of the computer program may be loaded and/or installed onto the device 800 via the ROM 802 and/or the communication unit 809. When the computer program is loaded into the RAM 803 and executed by the computing unit 801, one or more steps of the method for improving recognition accuracy of object attributes described above may be performed. Alternatively, in other embodiments of the present disclosure, the computing unit 801 may be configured to perform the method for improving recognition accuracy of object attributes by any other suitable means, such as firmware.

Various embodiments of the systems and techniques described above herein may be implemented in digital electronic circuit systems, integrated circuit systems, field-programmable gate arrays (FPGAs), application-specific integrated circuits (ASICs), application-specific standard products (ASSPs), system-on-chip (SoC) systems, complex programmable logic devices (CPLDs), computer hardware, firmware, software, and/or combinations thereof. Such embodiments may include implementation in one or more computer programs that are executable and/or interpretable on a programmable system including at least one programmable processor. The programmable processor may be a special-purpose programmable processor or a general-purpose programmable processor, and is configured to receive data and instructions from a storage system, at least one input device, and at least one output device, and transmit data and instructions to the storage system, the at least one input device, and the at least one output device.

Program code for implementing the methods of the present disclosure may be written in any combination of one or more programming languages. Such program code may be provided to a processor or controller of a general-purpose computer, a special-purpose computer, or another programmable data processing device, such that the program code, when executed by the processor or controller, causes the functions and/or operations specified in the flowcharts and/or block diagrams to be implemented. The program code may execute entirely on a machine, partly on a machine, partly on a machine as a standalone software package and partly on a remote machine, or entirely on a remote machine or server.

In the context of the present disclosure, a machine-readable medium may be a tangible medium that is able to contain or store a program for use by, or in connection with, an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include, but are not limited to, an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

To provide interaction with a user, the systems and techniques described herein may be implemented on a computer having a display device for displaying information to the user (for example, a cathode ray tube (CRT) or a liquid crystal display (LCD) monitor), and a keyboard and a pointing device (for example, a mouse or a trackball), through which the user is able to provide input to the computer. Other types of devices may also be used to provide interaction with a user. For example, feedback provided to the user may be any form of sensory feedback (such as visual feedback, auditory feedback, or tactile feedback), and input from the user may be received in any form, including acoustic input, voice input, or tactile input.

The systems and techniques described herein may be implemented in a computing system that includes back-end components (for example, as a data server), or a computing system that includes middleware components (for example, an application server), or a computing system that includes front-end components (for example, a user computer having a graphical user interface or a web browser through which a user is able to interact with implementations of the systems and techniques described herein), or any combination of such back-end components, middleware components, and front-end components. Components of the system may be interconnected by any form or medium of digital data communication, such as a communication network. Examples of communication networks include a local area network (LAN), a wide area network (WAN), and the Internet.

The computer system may include clients and servers. The clients and servers are generally remote from each other and typically interact through a communication network. The relationship of client and server arises by virtue of computer programs running on the respective computers and having a client-server relationship with each other. The server may be a cloud server, a server in a distributed system, or a server integrated with a blockchain.

It should be understood that the various forms of processes illustrated above may be reordered, steps may be added, or steps may be omitted. For example, the steps described in the present disclosure may be executed in parallel, executed sequentially, or executed in a different order, provided that the expected results of the technical solutions of the present disclosure are achieved. No limitation is imposed herein in this regard.

The foregoing descriptions are merely specific embodiments of the present disclosure, and the scope of protection of the present disclosure is not limited thereto. Any modifications, variations, or substitutions that may be readily conceived by those skilled in the art within the technical scope disclosed herein shall fall within the scope of protection of the present disclosure. Accordingly, the scope of protection of the present disclosure shall be defined by the scope of the claims.

What is claimed is:

1. A method for improving recognition accuracy of object attributes, applied to a target node, and the method comprising:
obtaining first attribute data of a target object in a sensing region;
in response to the first attribute data failing to satisfy a predetermined sensing condition, querying nodes by the target node to determine N target auxiliary nodes matching the first attribute data, wherein N is a positive integer greater than or equal to 1; and
obtaining data from the N target auxiliary nodes, wherein the data comprises second attribute data of the target object in the sensing region, and an accuracy of the second attribute data is higher than an accuracy of the first attribute data.

2. The method according to claim 1, wherein
the target node comprises a first role node configured to manage one or more second role nodes; and
querying the nodes by the target node to determine the N target auxiliary nodes matching the first attribute data comprises:
obtaining pre-configuration information of second role nodes located in the sensing region, wherein the pre-configuration information comprises fixed position information of the second role nodes; and
determining, based on the pre-configuration information, from the second role nodes located in the sensing region, N nodes matching the first attribute data to be the N target auxiliary nodes.

3. The method according to claim 1, wherein
the target node comprises a first role node configured to manage one or more second role nodes; and
querying the nodes by the target node to determine the N target auxiliary nodes matching the first attribute data comprises:
initiating a query request to second role nodes located in the sensing region; and
determining, based on feedback information from the second role nodes located in the sensing region, N nodes matching the first attribute data to be the N target auxiliary nodes, wherein the feedback information comprises real-time position information of the second role nodes in response to the query request.

4. The method according to claim 1, wherein
the target node comprises a second role node;
the first attribute data is used to represent a position of the target object in the sensing region; and
querying the nodes by the target node to determine the N target auxiliary nodes matching the first attribute data comprises:
determining, based on the first attribute data, a target management node of the target node, wherein the target management node is a node managing the target node, and a sensing region of the target management node covers at least the position of the target object in the sensing region;
in response to the target node accessing a communication domain where the target management node is located, sending a request to the target management node; and
in response to a determination that information fed back by the target management node in the communication domain in response to the request matches specified information, determining the target management node to be a target auxiliary node.

5. The method according to claim 1, wherein
the target node comprises a first role node and at least one second role node, the first role node being configured to manage one or more second role nodes; and
querying the nodes by the target node to determine the N target auxiliary nodes matching the first attribute data comprises:
obtaining pre-configuration information of M second role nodes located in the sensing region other than the at least one second role node, wherein the pre-configuration information comprises fixed position information of the M second role nodes, and M is a positive integer greater than or equal to 1; and
determining, based on the pre-configuration information of the M second role nodes, from the M second role nodes, N nodes matching the first attribute data to be the N target auxiliary nodes.

6. The method according to claim 1, wherein
the target node comprises a first role node and at least one second role node, the first role node being configured to manage one or more second role nodes; and
querying the nodes by the target node to determine the N target auxiliary nodes matching the first attribute data comprises:
initiating a query request to L second role nodes located in the sensing region other than the at least one second role node, wherein L is a positive integer greater than or equal to 1; and
determining, based on feedback information of the L second role nodes, from the L second role nodes, N nodes matching the first attribute data to be the N target auxiliary nodes, wherein the feedback information comprises real-time position information of the L second role nodes in response to the query request.

7. The method according to claim 1, wherein obtaining the data from the N target auxiliary nodes comprises:
obtaining the second attribute data of the target object in the sensing region; and
obtaining third attribute data, by processing the first attribute data and the second attribute data, wherein an accuracy of the third attribute data is higher than the accuracy of the first attribute data.

8. The method according to claim 1, wherein obtaining the first attribute data of the target object in the sensing region comprises:
in response to the target object appearing in the sensing region of the target node, based on a sensing signal transmitted by the target node and a sensing signal received by the target node, obtaining the first attribute data of the target object in the sensing region.

9. The method according to claim 1, further comprising:
outputting the second attribute data; or
in response to the first attribute data satisfying the predetermined sensing condition, outputting the first attribute data.

10. A device for improving recognition accuracy of object attributes, comprising:
one or more processors configured to: obtain first attribute data of a target object in a sensing region, and, in response to the first attribute data failing to satisfy a predetermined sensing condition, query nodes to determine N target auxiliary nodes matching the first attribute data, wherein N is a positive integer greater than or equal to 1; and
a transceiver configured to obtain data from the N target auxiliary nodes, wherein the data comprises second attribute data of the target object in the sensing region, and an accuracy of the second attribute data is higher than an accuracy of the first attribute data.

11. The device according to claim 10, wherein the one or more processors are further configured to:
obtain pre-configuration information of second role nodes located in the sensing region, the pre-configuration information comprising fixed position information of the second role nodes; and
determine, based on the pre-configuration information, from the second role nodes, the N target auxiliary nodes.

12. The device according to claim 10, wherein the one or more processors are further configured to:
initiate a query request to second role nodes located in the sensing region via the transceiver; and
determine, based on feedback information from the second role nodes, the N target auxiliary nodes, the feedback information comprising real-time position information of the second role nodes.

13. The device according to claim 10, wherein the device is configured as a second role node, the first attribute data represents a position of the target object, and the one or more processors are further configured to:
determine, based on the first attribute data, a target management node configured to manage the device, wherein a sensing region of the target management node covers at least the position of the target object;
in response to the device accessing a communication domain where the target management node is located, cause the transceiver to send a request to the target management node; and
in response to a determination that information fed back by the target management node matches specified information, determine the target management node to be a target auxiliary node.

14. The device according to claim 10, wherein the device comprises a first role node and at least one second role node, and the one or more processors are further configured to:
obtain pre-configuration information of M second role nodes located in the sensing region other than the at least one second role node, the pre-configuration information comprising fixed position information of the M second role nodes, wherein M is a positive integer greater than or equal to 1; and
determine, based on the pre-configuration information of the M second role nodes, the N target auxiliary nodes from the M second role nodes.

15. The device according to claim 10, wherein the device comprises a first role node and at least one second role node, and the one or more processors are further configured to:
cause the transceiver to initiate a query request to L second role nodes located in the sensing region other than the at least one second role node, wherein L is a positive integer greater than or equal to 1; and
determine, based on feedback information from the L second role nodes, the N target auxiliary nodes from the L second role nodes, wherein the feedback information comprises real-time position information of the L second role nodes in response to the query request.

16. A non-transitory computer-readable storage medium storing a computer program, wherein the computer program, when executed by at least one processor of a device configured as a target node, causes the at least one processor to perform operations comprising:
obtaining first attribute data of a target object in a sensing region;
in response to the first attribute data failing to satisfy a predetermined sensing condition, querying nodes by the target node to determine N target auxiliary nodes matching the first attribute data, wherein N is a positive integer greater than or equal to 1; and
obtaining data from the N target auxiliary nodes, wherein the data comprises second attribute data of the target object in the sensing region, and an accuracy of the second attribute data is higher than an accuracy of the first attribute data.

17. The non-transitory computer-readable storage medium according to claim 16, wherein
the target node comprises a first role node configured to manage one or more second role nodes; and
querying the nodes by the target node to determine the N target auxiliary nodes matching the first attribute data comprises:
obtaining pre-configuration information of second role nodes located in the sensing region, wherein the pre-configuration information comprises fixed position information of the second role nodes; and
determining, based on the pre-configuration information, from the second role nodes located in the sensing region, N nodes matching the first attribute data to be the N target auxiliary nodes.

18. The non-transitory computer-readable storage medium according to claim 16, wherein
the target node comprises a first role node configured to manage one or more second role nodes; and
querying the nodes by the target node to determine the N target auxiliary nodes matching the first attribute data comprises:
initiating a query request to second role nodes located in the sensing region; and
determining, based on feedback information, from the second role nodes located in the sensing region, N nodes matching the first attribute data to be the N target auxiliary nodes, wherein the feedback information comprises real-time position information of the second role nodes in response to the query request.

19. The non-transitory computer-readable storage medium according to claim 16, wherein
the target node comprises a second role node;
the first attribute data is used to represent a position of the target object in the sensing region; and
querying the nodes by the target node to determine the N target auxiliary nodes matching the first attribute data comprises:
determining, based on the first attribute data, a target management node of the target node, wherein the target management node is a node managing the target node, and a sensing region of the target management node covers at least the position of the target object in the sensing region;
in response to the target node accessing a communication domain where the target management node is located, sending a request to the target management node; and
in response to a determination that information fed back by the target management node in the communication domain in response to the request matches specified information, determining the target management node to be a target auxiliary node.

20. The non-transitory computer-readable storage medium according to claim 16, wherein
the target node comprises a first role node and at least one second role node, the first role node being configured to manage one or more second role nodes; and
querying the nodes by the target node to determine the N target auxiliary nodes matching the first attribute data comprises:
obtaining pre-configuration information of M second role nodes located in the sensing region other than the at least one second role node, wherein the pre-configuration information comprises fixed position information of the M second role nodes, and M is a positive integer greater than or equal to 1; and
determining, based on the pre-configuration information of the M second role nodes, from the M second role nodes, N nodes matching the first attribute data to be the N target auxiliary nodes.
